(19) United States
(12) Patent Application Publication
(10) Pub. No.: US 2012/0310123 A1
(43) Pub. Date: Dec. 6, 2012

(54) DEVICE AND METHOD FOR CONTROLLED HEART-LUNG-REANIMATION WHEN THE HEART STOPS

(76) Inventor: Sebastian MÖSSMER, Munchen (DE)

(21) Appl. No.: 13/447,865

(22) Filed: Apr. 16, 2012

(30) Foreign Application Priority Data
Apr. 16, 2011 (DE) 20,2011,005,364UI
Nov. 17, 2011 (DE) 10,2011,118,803.0

(51) Int. Cl. A61H 31/00

(52) U.S. Cl. 601/41

(57) ABSTRACT

A method and a device (1) for controlled cardio pulmonary resuscitation is presented with the submitted invention, which is capable of performing a quick and uncomplicated reanimation of a human body in case of cardiac arrest. The geometric dimensions of the inventive device 1 are between about 10 and 20 cm in diameter and about 6 to 12 cm in height. A mechanical pressure (K) is exerted on the pressure transfer agent (2) in an application, wherein the pressure generates a signal (S3, S3′) perceivable with human organs upon reaching of a maximum force exertion (Kmax).

The present invention is concerned with a device and with a method for controlled heart lung resuscitation in case of cardiac arrest, in particular with a device, which is simple and quick to operate and which supports the user with easy to understand helping aids.

Such devices are known in the state of the art from the document WO 91/19473 P1. This printed document discloses a resuscitation apparatus, which is particularly suited for the resuscitation of a patient with cardiac arrest and which comprises a frame which is equipped with at least one stamp, which operates cyclically on the thorax of a patient, wherein the complete device is integrated in a corset which is laid with different straps around the trunk of the human body.

A further device for heart massage and artificial respiration has become known from the German printed patent document DE 36 17 327 A1. A single persons performs with this device both a cyclical heart massage as well as also an artificial respiration.

A heart massage apparatus to be carried has become known furthermore from the German printed patent document DE 1491611, which comprises a base plate and a stamp disposed above, wherein the stamp is cyclically actuated with a pneumatic mechanics and acts in this fashion on the thorax of the human body. Since it is in general important in case of a cardiac arrest to perform a resuscitation as quickly as possible, frequently the available apparatus are to demanding in their handling and are complicated to be operated, such that thereby valuable time for the resuscitation of the human body can get lost, which has far-reaching consequences.

Therefore it is the object of the present invention to furnish a simple and easy to operate apparatus for heart lung resuscitation, which is capable to let a controlled pressure act cyclically on the thorax of the human body. This object is resolved with the characterizing features of the main claims. Further invention important features can be taken from the sub claims and the detailed description.

The invention device for the controlled heart lung resuscitation with living things, in particular of the human body, in cardiac arrest is characterized by at least one pressure transfer agent with a pressure display which at least directly and/or indirectly is disposed with the rib cage at a predetermined location and which generates a signal (S) perceivable by the sense organs is generated upon occurrence of a limiting pressure (Kmax). The method working with this invention device is characterized by the following procedural steps:

P1 positioning of the device on the thorax of the human body;

P2 exertion of a mechanical pressure (K) on the surface of the device up to reaching a limiting pressure (Kmax); and

P3 generating of a signal (S3, S3′) perceivable by the human sensing organs;

P4 complete taking back of the mechanical pressure (K) after perception of the signal (S);

P5 renewed exertion of the mechanical pressure (K) on the surface of the device, wherein the steps P2 through P4 are repeated.

Here it is an advantage for the device that at least one pressure transfer agent is a relatively rigid element, which is directly or indirectly with at least one further pressure transfer agent in connection.

A further advantage comprises that at least one pressure transfer agent is in direct connection with the body to be treated, wherein the supporting surface of the pressure transfer agent is adapted to be in an anatomical situation. It is also advantageous that the pressure display and/or the limiting pressure display are electronically as well as mechanically and/or optically formed. It is further advantageous that the unit generating the signal (S) is equipped with at least one element receiving the pressure.

A further advantage comprises that at least one pressure transfer agent is formed back expandingly.

It is furthermore advantageous that at a predetermined location, preferably on the bottom side or in the hand reaching of the upper side there is disposed a characterizing element, which determines the proper positioning of the device on the rib cage.

It is furthermore advantageous that the device exhibits an integrated electronics with at least one sensor, which sensor receives the mechanical pressure and generates a signal through the electronics.

A further advantage is to be seen in that the electronics is supplied by an internal or external battery.

The invention is explained in more detail by way of drawings in the following. There is shown in:

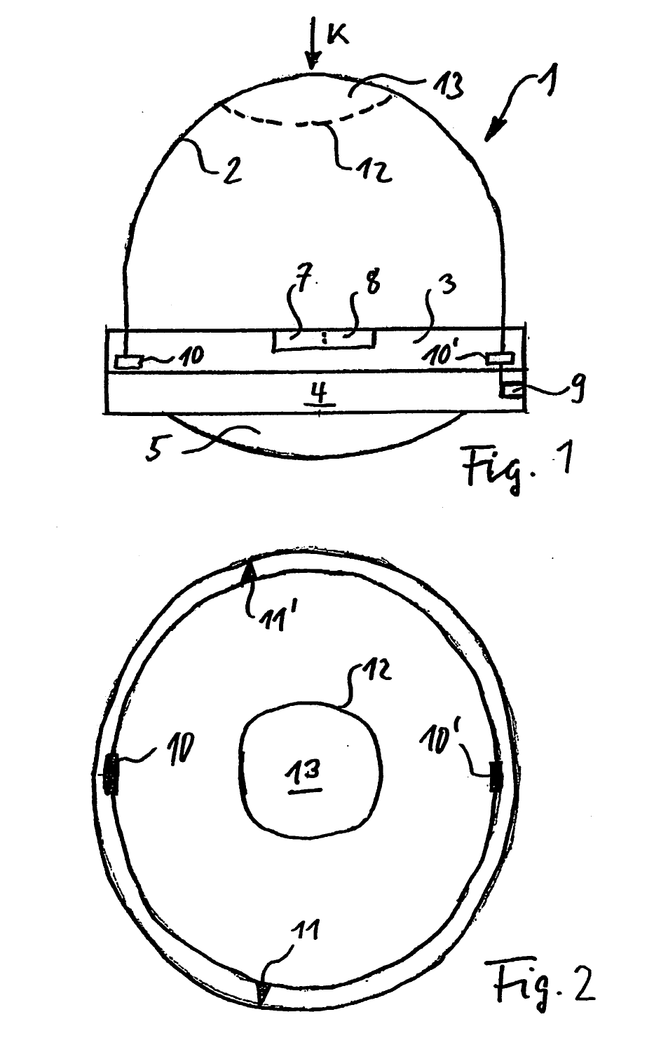

FIG. 1 a schematic side elevational view of an embodiment example of an invention device (1) with at least one pressure transfer agent (2);

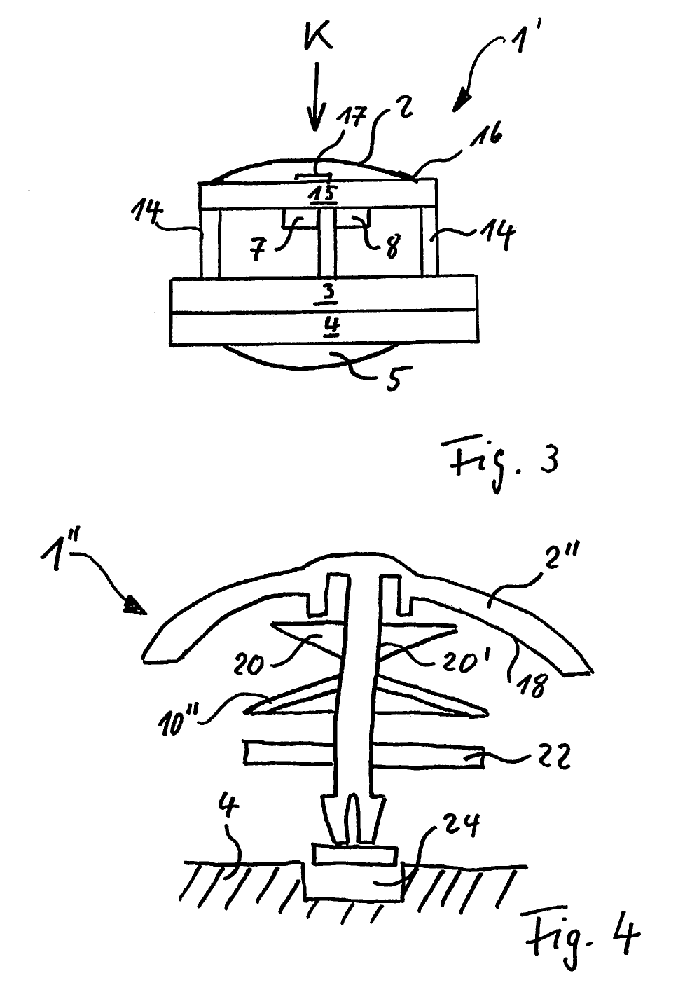

FIG. 2 a schematic top plan view of the device (1) of FIG. 1;

FIG. 3 a schematic side view of a further embodiment example of the device (1′);

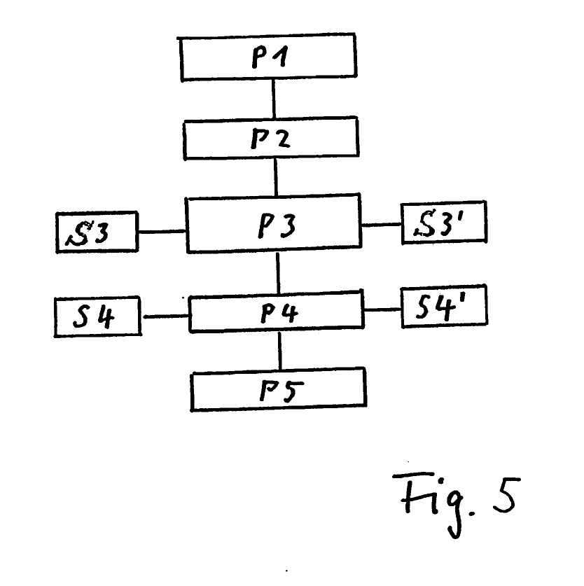

FIG. 4 a schematic exploded representation of a further embodiment example (1″) of the present invention with a conical ring element (20) and a pressure receiving element (10″);

FIG. 5 a schematic block diagram of the individual procedural steps (P1-P5) during a resuscitation process.

FIG. 1 shows a schematic side view of a possible embodiment example of the device 1 with its essential device components. This device 1 comprises a first pressure transfer agent 2, which is formed arcuate and is connected at the ends with a flat relatively rigid element 3. The rigid element 3, which can also be formed arched, exhibits at its bottom side a further pressure transfer agent 4 which is produced from a pliable material, for example a special foam material as resistant moss rubber. A formed part 5 is disposed at the bottom side of this pliable element 4 corresponding to the anatomical situation of the thorax, which formed part 5 thereby assures a proper and secure positioning of the device 1 on the thorax of the rib cage. The pliable element 4 and the formed part 5 can also be formed as a single formed part out of a suitable foam material, which does not slip on the skin of the human body. The bent pressure transfer agent 2 is formed such that the surface of the pressure transfer agent 2 experiences initially a mechanical tension upon exertion of a mechanical pressure (K) and upon occurrence of the limiting pressure (Kmax) a part region of the surface jumps like snaps and thereby generates a clearly perceivable click sound, which signals that the maximum pressure (Kmax) has been reached. Here the arched formed transfer agent 2 serves amongst others as a resonance body, which clearly increases the acoustic signal (S3). Here the surface snaps inwardly or the like up to the dashed line 12 and thereby generates a clearly hearable click signal (S3). According to a refined embodiment example of the present invention sensors 10,10′, receiving the pressure for example extension measurement strips are disposed at the end of the pressure transfer agent 2, which feed a signal to the electronics 7 and thereby a clearly perceivable acoustic or optical signal (S3′) is generated. The electronics 7 for example integrated into the pressure transfer agent 3 is fed by an also internal or external battery 8. The electrical contact 9 is amongst others connected to the sensors 10,10′ and can also be formed as a USB plug receptacle, in order to transfer therewith further cardiologically important signals.

The FIG. 2 shows a schematic top plan view onto the device 1 shown in FIG. 1. The rigid element 3 and force transfer agent 2 are made round or oval in the present embodiment example, which however represents only a symbolic indication such that also any other arbitrary sensible forming of the individual construction elements is possible. It is decisive that the shape is so adapted to the ergonomic form of the hand and of the rib cage that all pressure transfer elements effect an optimum pressure exertion and a uniform pressure transfer initially onto the pressure transfer element 3 on the one hand and on the rib cage on the other hand. The flat rigid force transfer element 3 is slightly larger than the diameter of the force transfer element 2 in the present embodiment example, thereby a small edge is formed. Two marking elements 11, 11′ are disposed on this edge or at another suitable position of the device 1 and the marking elements 11, 11′ serves as positioning aids for the whole or setting of the device 1 on the thorax of the human body. A further positioning aid can be a flexible element, for example a band or a cord, which is made round the neck of the patient in order to find thereby the proper heart position. The concentric circle 12 represents the limiting line for the click sound generating element 13, which can be either a notch into the material of the pressure transfer agent 2 or similar to a perforation, such that at a pregiven pressure load (Kmax) the material part 13 or, respectively, the pressure display device jump like folds down and thereby generates a signal sound (S3). Every other embodiment of a mechanical pressure and measurement display is within the sense of the present invention.

The FIG. 3 shows a further embodiment form of the present invention in a schematic presentation of the device 1′. At least three struts or braces 14 are fixedly disposed on the relatively rigid flat pressure transfer element 3, wherein a further flat plate like element 15 is disposed on the upper end of the struts 14, wherein an arched pressure transfer agent 2′ extends over the further flat plate like element 15, wherein the ends 16 of the arched pressure transfer agent 2′ are easily shiftable disposed on the flat element 15. Upon exertion of a force K onto the surface of the pressure transfer agent 2′, the pressure transfer agent 2′ sinks so far downwardly until it has reached the surface of the flat element 15 and therewith touches a sensor 17, wherein the sensor 17 generates a signal which signal is fed to the electronics 7, and wherein the electronics 7 in turn generates a signal of an optical and/or acoustic nature. The further reference characters correspond to those in FIG. 1 or, respectively, in FIG. 2.

FIG. 4 shows schematically a further embodiment example of the present invention in an exploded view of the most important constructive elements. The arched pressure transfer agent 2″ exhibits at the bottom side 18 a ring-shaped web 19, wherein the web 19 acts on a conical ring element 20 with a center borehole 21 during the pressure generation (K). The pressure receiving element 10″ is disposed between the further flat ring disk 22, which element 10″ is disposed as a projecting and raised dish plate spring out of spring steel according to the present embodiment example, wherein the plate spring switches upon a predetermined load (Kmax) and beats against the conical ring element 20. The stroke transfers thus over the ring-shaped web 19 onto the first pressure transfer element 2″, which first pressure transfer element 2″ serves as a resonance body and generates a clearly audible sound. The guide rod 23 pointing downwardly in this representation, wherein ray shaped ribs not shown here are disposed at the guide rod 23, serves amongst others for the centered and homogeneous force transfer onto the form part 4, or, respectively, 5 which exhibits a recess 24 in the middle, into which recess 24 the guide rod 23 submerges upon exertion of force onto the first pressure transfer agent 2″. The plate spring 10″ or, respectively, the element receiving the pressure can assume every arbitrary outer shape. The outer shape can be formed round, oval, multiple corner or star like. However it is important that the plate spring generates a signal of any kind as described above upon a predetermined load (Kmax).

The FIG. 5 shows a block diagram of the essential process steps (P1-P5) with application of the device 1 according to the invention. The first step P1 comprises to place the device defectively onto the rib cage at a predetermined location and to position. The second step P2 comprises to exert a mechanical pressure with the hand on to the surface of the pressure transfer agent 2,2′, 2″ of the device 1, 1′, 1″ and limiting pressure (Kmax) has been reached, wherein the limiting pressure lies between 30 and 40 kilo pond, however preferably is applied at 35 kilo pond. After reaching of the limiting pressure (Kmax) the device generates either mechanically and/or electrically a signal (S3,S3′) receivable by a human sensing organ, which says to the user that the limiting pressure (Kmax) has been reached. As soon as this limiting pressure has been reached, then the mechanical pressure is immediately and completely to be taken back (P4) and then after a predetermined time the pressure process is to be cyclically repeated in a further process step (P5).

1. Device (1) for controlled heart lung resuscitation at living things, in particular of the human body with cardiac arrest characterized in that at least a pressure transfer agent (2, 3, 4) and at least an element (10) receiving a pressure with a pressure display, which upon entry of a limiting pressure (Kmax) generates a signal (S3) receivable by the human sensing organs.

2. Device according to claim 1 characterized in that at least one pressure transfer agent (3) is a relatively rigid element (3), which is connected to at least one pressure transfer agent (2,3,4).

3. Device according to claim 1 characterized in that the pressure transfer agent (4) is directly/indirectly in connection with the body to be treated and is adapted to the anatomic situation of the body.

4. Device according to claim 1 characterized in that pressure display and/or the limiting pressure display (10″, 13) is formed electrical and/or mechanical and/or optical or is a combination of the precedingly recited agents.

5. Device according to claim 1 characterized in that at least one pressure transfer agent (2,3,4) stands in connection with the pressure receiving element (10, 10′, 10″) and generates a first signal (S3, S3′) upon reaching of the limiting pressure (Kmax).

6. Device according to claim 1 characterized in that at least one pressure transfer agent (2,10″) is formed back expanding and thereby generates at least a second signal (S4, S4′).

7. Device according to claim 1 characterized in that at a predetermined position of the device (1), preferably on the bottom side or in the edge region of the opposite sides, a characterizing element (11) is disposed which determines the proper position of the device (1) on the rib cage.

8. Device according to claim 1 characterized in that an integrated electronics (7) with at least one sensor (10, 10′), which accepts the mechanical pressure (K) and generates a signal through the electronics (7).

9. Device according to claim 1 characterized in that the electronics (7) is supplied by an internal or external battery (8).

10. Device according to claim 1 characterized in that at least one electrical contact (9) is coordinated at a suitable position, wherein the electrical contact (9) stands in connection with at least one pressure receiving element (10, 10′, 10″).

11. Method for controlled heart-lung-resuscitation at living things in particular of the human body characterized by the following procedural steps:
P1 positioning of the device on the rib cage above the heart;
P2 exertion of a mechanical pressure (K) onto the surface of the device (1) according to claim 1 unto an adjustable limiting pressure (Kmax) has been reached;
P3 generating of a signal (S3, S3′) perceivable by the human sensing organs;
P4 complete taking back of the mechanical pressure (K) from the surface of the device (1) after perceiving of a signal (S4, S4′);
P5 renewed application of a mechanical pressure (K) on the surface of the device (1), wherein the steps P1-P4 are cyclically repeated.

12. Method according to claim 11 characterized in that device (1) is arranged at least indirectly and/or directly with the rib cage to be treated at a predetermined location.

13. Method according to claim 11 characterized in that the device exhibits a switch such that, upon reaching of an adjustable limiting pressure (Kmax), at least one electrical contact is actuated.
